(19) United States
(12) Patent Application Publication
(10) Pub. No.: US 2025/0158377 A1
(43) Pub. Date: May 15, 2025

(54) HYBRID ELECTRIC VEHICLE WITH SELF-ADJUSTING CABLE GUIDE SYSTEM AND METHOD EMPLOYED THEREOF

(71) Applicant: VENKATA NARSIMHA REDDY NALAMALA, Hyderabad (IN)

(72) Inventor: VENKATA NARSIMHA REDDY NALAMALA, Hyderabad (IN)

(21) Appl. No.: 18/434,873

(22) Filed: Feb. 7, 2024

(30) Foreign Application Priority Data
Nov. 10, 2023 (IN) 202341077053

(51) Int. Cl. H02G 11/02; B60L 15/40; B60L 53/18

(52) U.S. Cl. CPC H02G 11/02; B60L 15/40; B60L 53/18; B60L 2200/40

(57) ABSTRACT

Exemplary embodiments of the present disclosure are directed towards hybrid electric vehicle with self-adjusting cable guide system comprising a cable reeler horizontally placed on the hybrid electric vehicle chassis. Cable reeler configured to establish connection between flexible trailing cable originating from grid power source to vehicle power control panel through changeover switch. Changeover switch configured to facilitate use of grid power for normal work and battery power for on road travel. The power control panel configured to supply electric power to electric motor of the hybrid electric vehicle. The cable reeler includes a self-adjusting cable guide and a hydraulic motor. The hydraulic motor is configured to wind the trailing cable when the hybrid electric vehicle moves toward the grid power source. Hydraulic motor configured to unwind trailing cable when hybrid electric vehicle moves away from grid power source.

### CROSS-REFERENCE TO RELATED APPLICATIONS

This patent application claims priority benefit of Indian Patent Application No: 202341077053, entitled “HYBRID ELECTRIC VEHICLE WITH SELF-ADJUSTING CABLE GUIDE SYSTEM AND METHOD EMPLOYED THEREOF”, filed on 10 Nov. 2023. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever

### TECHNICAL FIELD

The present disclosure generally relates to electric vehicles' power management and their application in the agricultural machinery field. More particularly, the present disclosure relates to hybrid electric vehicle that uses grid power for field work and battery power for on road travel with a self-adjusting cable guide system and method employed thereof.

### BACKGROUND

Generally, a farmer always tries to make farming easy and accomplish it in a way so that less amount of money or labour is needed. However, the agricultural sector is not without its challenges. Traditional manual farming practices, while deeply rooted in history, face mounting obstacles due to the migration of the youth to urban centers, resulting in a severe shortage of labor in rural areas. This labor scarcity, in turn, leads to increased input costs, hindering the efficiency and sustainability of agriculture.

To address this labor shortage, mechanized farming using diesel engine-driven tractors became a popular alternative. These tractors could be equipped with various implements, including plows, rotovators, cultivators, sprayers, and harvesters, effectively replacing manual labor in many agricultural tasks. While mechanized farming offered a solution to the labor shortage, it introduced a new set of challenges. One of the main drawbacks of diesel engine-driven tractors is the continually escalating costs associated with fuel and maintenance. In addition to this, the environmental impact of diesel consumption, where approximately 10% of the country's diesel production is consumed by tractors, cannot be overlooked. On average, a tractor consumes about 5 liters of diesel per hour while performing farm work, translating to significant daily expenses.

The rising costs of fuel have significantly contributed to the overall increase in the input costs of farming, far outpacing the rate of increase in the prices of agricultural produce. This economic discrepancy is diminishing the net income of farmers, reducing their purchasing power over time, especially when compared to individuals engaged in other professions. While replacing the diesel engine with an electric motor powered by grid electricity to operate tractors is a concept, it has not gained widespread acceptance due to several challenges. Notably, at least two individuals are required to manage the grid-powered cable while the tractor is in operation, introducing safety concerns for those handling the cable. This limitation has deterred the adoption of electric motor-driven tractors as a viable alternative to diesel-powered ones.

Furthermore, battery-operated electric tractors, despite being an environmentally friendly option, are currently limited to the maintenance of small home gardens. The high initial cost of these battery-operated electric tractors and challenges related to charging infrastructure have hindered their application in mainstream farming. For example, a 15 kW battery-operated tractor necessitates a 100 kWh capacity lithium-ion battery pack to support 8 hours of continuous operation, increasing the tractor's cost by 5 to 6 times when compared to diesel tractors. The significant cost differential places these tractors beyond the reach of ordinary farmers. Therefore, unless there are substantial reductions in battery prices and improvements in charging infrastructure, battery-operated electric tractors are unlikely to see widespread adoption in farming in the near future.

In the light of the aforementioned discussion, there exists a need for a certain system with novel methodologies that would overcome the above-mentioned disadvantages.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a hybrid electric vehicle that uses grid power for field work and battery power for on road travel with self-adjusting cable guide system and method employed thereof.

An objective of the present disclosure is directed towards hybrid electric vehicles powered by grid electricity with the incorporation of a cable reeler system for agricultural farm operations.

Another objective of the present disclosure is directed towards providing a hybrid electric vehicle that significantly reduces input costs and minimizes the need for manual labor.

Another objective of the present disclosure is directed towards providing a cable reeler with a horizontally positioned drum on the hybrid electric vehicle that manages the power cable during turns.

Another objective of the present disclosure is directed towards providing a movable cable guide on the reeler shaft that ensures the cable maintains proper alignment and avoids damage.

Another objective of the present disclosure is directed towards implementing a movable cable guide that prevents power cable damage.

Another objective of the present disclosure is directed towards a system that enables the use of electric motor-driven vehicles/tractors powered by the grid as a replacement for diesel engine-driven tractors.

Another objective of the present disclosure is directed towards integrating a cable reeler into the hybrid electric vehicle that eliminates the need for manual cable handling personnel and improving safety and efficiency.

Another objective of the present disclosure is directed towards providing a hybrid electric vehicle that operates at minimal daily costs, with significant cost savings compared to diesel-powered tractors. This reduces farmers' input costs, decreases dependence on imported petroleum, and minimizes environmental pollution.

Another objective of the present disclosure is directed towards providing a radio-remote system that allows operators to control the hybrid electric vehicle from a distance.

Another objective of the present disclosure is directed towards a system that eliminates the need for complex and costly technologies like electronic software, robotics, artificial intelligence, and sensors, making it a practical and cost-effective solution for a wide range of agricultural applications.

Another objective of the present disclosure is directed towards a system that significantly reduces the input costs associated with agricultural farming, making it more economically sustainable for farmers.

Another objective of the present disclosure is directed towards utilizing grid power, the electric vehicle reduces the environmental impact associated with diesel-powered tractors, contributing to a cleaner and greener farming practice.

Another objective of the present disclosure is directed towards a system that reduces reliance on imported petroleum for farming operations, contributing to energy security and reducing the economic burden of fuel costs.

Another objective of the present disclosure is directed towards a system that avoids the complexity and expense of advanced technologies, such as electronic software and artificial intelligence.

According to an exemplary aspect, a cable reeler is horizontally placed on the hybrid electric vehicle chassis, whereby the cable reeler is configured to establish a connection between a flexible trailing cable originating from a power grid and a changeover switch of the hybrid electric vehicle to supply electric power to a power control panel.

According to another exemplary aspect, the power control panel is configured to supply the electric power to an electric motor of the hybrid electric vehicle, wherein the electric motor is mechanically coupled to a transmission of the hybrid electric vehicle, and the electric motor drives the hybrid electric vehicle through the transmission of the hybrid electric vehicle.

According to another exemplary aspect, the changeover switch of the hybrid electric vehicle enables the use of grid power for normal work and battery power for on road travel.

According to another exemplary aspect, the cable reeler comprises a self-adjusting cable guide and a hydraulic motor, wherein the hydraulic motor is configured to wind the trailing cable when the hybrid electric vehicle moves toward the power grid (grid power source), the hydraulic motor configured to un-wind the trailing cable when the hybrid electric vehicle moves away from the power grid (grid power source).

According to another exemplary aspect, wherein the hybrid electric vehicle comprises a radio remote transmitter is configured to enable an operator to manage the hybrid electric vehicle's functions and movements from a distance.

According to another exemplary aspect, wherein the radio remote transmitter comprises one or more designated buttons to manage the hybrid electric vehicle's functions and movements from a distance.

According to another exemplary aspect, wherein the hybrid electric vehicle comprises a radio receiver is configured to receive control signals from the radio remote transmitter to control the hybrid electric vehicle's movements and functions.

According to another exemplary aspect, wherein the changeover switch is configured to enable an operator to select a power source from at least one of: the power grid; and a battery unit.

According to another exemplary aspect, wherein the battery unit facilitates the vehicles movement on road from one place of work to another place of work.

According to another exemplary aspect, wherein the self-adjusting cable guide is attached to the cable reeler support shaft through one or more bearings.

According to another exemplary aspect, wherein the hybrid electric vehicle comprises a power distribution unit configured to control the power distribution from the power grid to one or more subsystems of the hybrid electric vehicle.

According to another exemplary aspect, wherein the power distribution unit comprises an MCB is configured to enable the operator to supply electric power to the hybrid electric vehicle by turning on the MCB.

According to another exemplary aspect, wherein the hybrid electric vehicle comprises a power control panel is configured to supply 415 Volts of AC grid power for normal work and DC battery unit power for on road travel to the electric motor through VFD (variable frequency drive)

According to another exemplary aspect, wherein the hybrid electric vehicle comprises an electro-hydraulic module configured to control the cable reeler's Rotational movements.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is an example block diagram depicting a schematic representation of a hybrid electric vehicle with a self-adjusting cable guide system, in accordance with one or more exemplary embodiments.

FIG. 2 is an example embodiment of the hybrid electric vehicle with a self-adjusting cable guide system, in accordance with one or more exemplary embodiments.

FIG. 3 is an example flow diagram depicting a method for a self-adjusting cable guide integration of a hybrid electric vehicle, in accordance with one or more exemplary embodiments.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

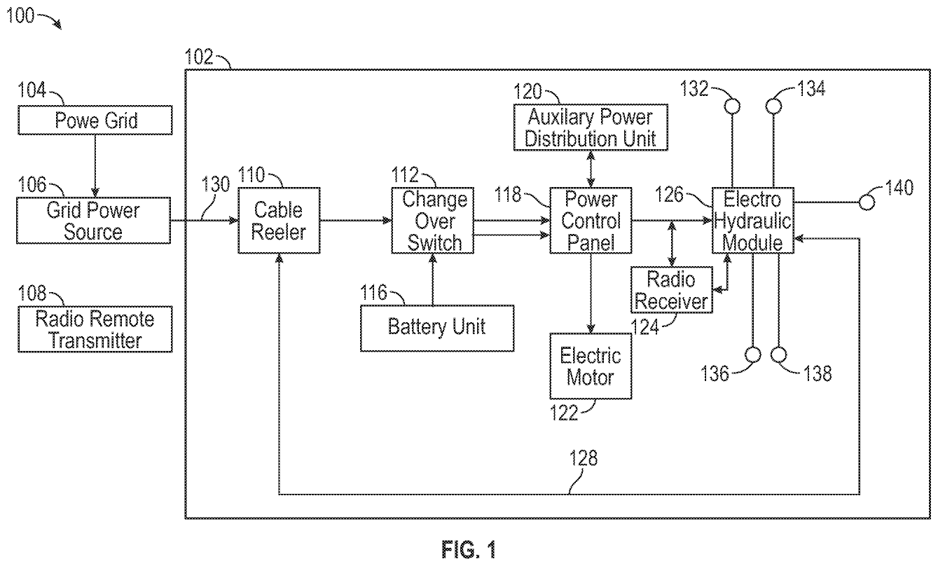

Referring to FIG. 1 is an example block diagram 100 depicting a schematic representation of a hybrid electric vehicle with a self-adjusting cable guide system, in accordance with one or more exemplary embodiments. The system 100 includes a hybrid electric vehicle 102, a power grid 104, a grid power source 106, a radio remote transmitter 108, a cable reeler 110, a change over switch 112, a battery unit 116, a power control panel 118, an auxiliary power distribution unit 120, an electric motor 122, a radio receiver 124, an electro hydraulic module 126, a hydraulic line 128, a flexible trailing cable 130, a clutch 132, a brake 134, a gear 136, a steering 138, and an implement 140.

The hybrid electric vehicle 102 may be configured to perform various agricultural tasks and maneuvers. The hybrid electric vehicle 102 may drive using electric power from the power grid 104 through the grid power source 106. The grid power source 106 may be configured to control the power distribution from the power grid 104 to various subsystems of the hybrid electric vehicle 102. The hybrid electric vehicle 102 may include but not limited to tractor, harvester, and the like. The hybrid electric vehicle 102 may include wheel drive or crawler drive. The radio remote transmitter 108 may be configured to enable the operator to manage the hybrid electric vehicle 102 functions and movements from a distance, enhancing operational efficiency. The hybrid electric vehicle 102 may include the cable reeler 110 may be configured to manage flexible trailing cable 130 during hybrid electric vehicle 102 operations. The flexible trailing cable 130 may include but not limited to power cable, electric cable, electric wire, and the like. The flexible trailing cable 130 may connected to the change over switch 112 through the cable reeler 110. The change over switch 112 may be configured to enable the operator to select a power source from the power grid 104 for normal work or battery unit 116 for on road travel. The change over switch 112 may be electrically coupled to the power control panel 118. The power control panel 118 may be configured to direct power source selection and distribution, ensuring that electricity is allocated efficiently from the grid or the battery to the electric motor 122 and other vehicle components, as needed for specific tasks. The electric motor 122 may be a primary propulsion unit for the hybrid electric vehicle 102, the electric motor 102 provides the mechanical power necessary to drive the vehicle and carry out various agricultural tasks. The radio receiver 124 may be configured to receive control signals from the radio remote transmitter 108 to control the hybrid electric vehicle 102 movements and functions. The electro hydraulic module 126 may be configured to control the hydraulic system within the hybrid electric vehicle 102 to ensure precise control over specific mechanical functions such as steering and implement 140 operations. The hydraulic line 128 may act as a conduit for the transmission of hydraulic power, facilitating efficient transmission of hydraulic power from the electro-hydraulic module to the hydraulic components of the hybrid electric vehicle 102. The flexible trailing cable 130 may act as the conduit for the transmission of electrical power from the grid power source 106 to the hybrid electric vehicle 102. The flexible trailing cable 130 may be configured to deliver seamless power to the hybrid electric vehicle 102. The clutch 132, brake 134, gear 136, and steering 138 may control the hybrid electric vehicle 102 speed, direction, and overall maneuverability. The clutch, brake, gear, and steering mechanisms allow the operator to navigate and operate the vehicle efficiently. The clutch 132, brake 134, gear 136, and steering 138 are pivotal for controlling the hybrid electric vehicle 102 speed, direction, and overall maneuverability. The clutch, brake, gear, and steering mechanisms allow the operator to navigate and operate the vehicle efficiently.

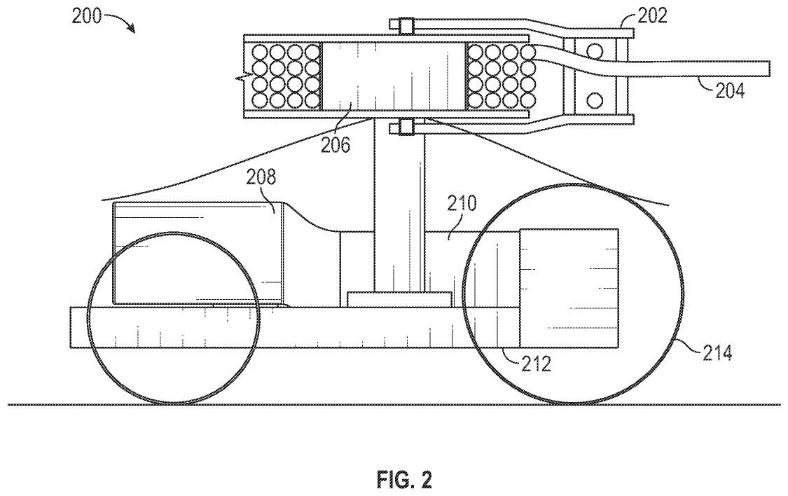

In accordance with one or more exemplary embodiments of the present disclosure, The cable reeler 110 will be horizontally placed on the hybrid electric vehicle chassis (not shown). The cable reeler 110 may be configured to establish a connection between a flexible trailing cable 130 originating from a power grid 104 and a changeover switch 112 of the hybrid electric vehicle 102 to supply electric power to a power control panel 118. The power control panel 118 may be configured to supply the electric power to an electric motor 122 of the hybrid electric vehicle 102 through a VFD (variable frequency drive). The electric motor 122 may be mechanically coupled to a transmission of the hybrid electric vehicle 102, the electric motor 122 drives the hybrid electric vehicle 102 through the transmission of the hybrid electric vehicle 102. The cable reeler 110 includes a self adjusting cable guide (as shown in the FIG. 2) and a hydraulic motor. The hydraulic motor may be configured to wind the trailing cable 130 when the hybrid electric vehicle 102 moves toward the grid power source 106. The hydraulic motor may be configured to un-winds the trailing cable 130 when the hybrid electric vehicle 102 moves away from the grid power source 106.

Referring to FIG. 2 is an example embodiment 200 depicting a schematic representation of a hybrid electric vehicle with a self-adjusting cable guide system, in accordance with one or more exemplary embodiments. The cable reeler 206 will be horizontally placed on the hybrid electric vehicle chassis 212. The cable reeler 206 may be configured to establish a connection between a flexible trailing cable 204 originating from a power grid 104 and a changeover switch 112 of the hybrid electric vehicle 102 to supply electric power to a power control panel 118. The power control panel 118 may be configured to supply the electric power to an electric motor 208 of the hybrid electric vehicle 102. The electric motor 208 may be mechanically coupled to a transmission 210 of the hybrid electric vehicle 102, the electric motor 208 drives the hybrid electric vehicle 102 through the transmission 210 of the hybrid electric vehicle 102. The cable reeler 206—includes a self adjusting cable guide 202 and a hydraulic motor. The hydraulic motor may be configured to wind the trailing cable 204 when the hybrid electric vehicle 102 moves toward the grid power source 106. The hydraulic motor may be configured to un-winds the trailing cable 204 when the hybrid electric vehicle 102 moves away from the grid power source 106.

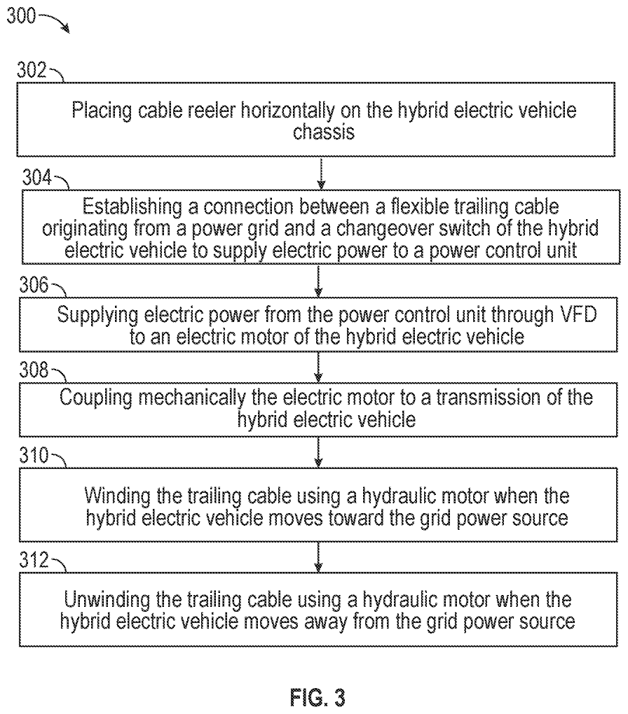

Referring to FIG. 3 is an example flow diagram 300 depicting a method for a self-adjusting cable guide integration of a hybrid electric vehicle, in accordance with one or more exemplary embodiments. The method 300 may be carried out in the context of the details of FIG. 1, FIG. 2. However, the method 300 may also be carried out in any desired environment. Further, the aforementioned definitions may equally apply to the description below.

The exemplary method 300 commences at step 302, placing the cable reeler drum horizontally on the hybrid electric vehicle chassis. Thereafter, at step 304, establishing a connection between a flexible trailing cable originating from a power grid and a changeover switch of the hybrid electric vehicle to supply electric power to a power control panel. Thereafter, at step 306, supplying electric power from the power control panel through VFD to an electric motor of the hybrid electric vehicle. Thereafter, at step 308, coupling mechanically the electric motor to a transmission of the hybrid electric vehicle. Thereafter, at step 310, winding the trailing cable using a hydraulic motor when the hybrid electric vehicle moves toward the grid power source. Thereafter, at step 312, unwinding the trailing cable using a hydraulic motor when the hybrid electric vehicle moves away from the grid power source.

In accordance with one or more exemplary embodiments of the present disclosure, the hybrid electric vehicle 102 comprises a radio remote transmitter 102 may be configured to enable an operator to manage the hybrid electric vehicle's 102 functions and movements from a distance.

In accordance with one or more exemplary embodiments of the present disclosure, the radio remote transmitter 108 comprises one or more designated buttons to manage the hybrid electric vehicle's 102 functions and movements from a distance.

In accordance with one or more exemplary embodiments of the present disclosure, the hybrid electric vehicle 102 comprises a radio receiver 124 may be configured to receive control signals from the radio remote transmitter 108 to control the hybrid electric vehicle's 102 movements and functions.

In accordance with one or more exemplary embodiments of the present disclosure, the changeover switch 112 may be configured to enable an operator to select a power source from at least one of: the power grid 104; and a battery unit 116.

In accordance with one or more exemplary embodiments of the present disclosure, the self-adjusting cable guide is attached to the cable reeler support shaft through one or more bearings.

In accordance with one or more exemplary embodiments of the present disclosure, the hybrid electric vehicle 102 comprises a grid power source 106 is configured to control the power distribution from the power grid 104 to one or more subsystems of the hybrid electric vehicle 102.

In accordance with one or more exemplary embodiments of the present disclosure, the grid power source comprises an MCB is configured to enable the operator to supply electric power to the hybrid electric vehicle by turning on the MCB.

In accordance with one or more exemplary embodiments of the present disclosure, wherein the hybrid electric vehicle 102 comprises a power control panel 118 may be configured to supply 415 Volts of grid power or power from the battery unit to the electric motor 122 through VFD (variable frequency drive).

In accordance with one or more exemplary embodiments of the present disclosure, wherein the hybrid electric vehicle 102 comprises an electro-hydraulic module 126 may be configured to control the cable reeler's 110 rotational movements.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus, the scope of the present disclosure is defined by the appended claims and includes both combinations and sub-combinations of the various features described hereinabove as well as variations and modifications thereof, which would occur to persons skilled in the art upon reading the foregoing description.

I claim:

1. A hybrid electric vehicle with a self-adjusting cable guide system, comprising:
a cable reeler horizontally placed on the hybrid electric vehicle chassis, whereby the cable reeler configured to establish a connection between a flexible trailing cable originating from a grid power source and a changeover switch of the hybrid electric vehicle to supply electric power to a power control panel;
the power control panel configured to supply the electric power to an electric motor of the hybrid electric vehicle through a VFD (variable frequency drive), wherein the electric motor mechanically coupled to a transmission of the hybrid electric vehicle, the electric motor drives the hybrid electric vehicle through the transmission of the hybrid electric vehicle;
the changeover switch of the hybrid electric vehicle enables the use of grid power for normal work and battery power for on road travel; and
the cable reeler comprises a self adjusting cable guide and a hydraulic motor, wherein the hydraulic motor configured to wind the trailing cable when the hybrid electric vehicle moves toward the grid power source, the hydraulic motor configured to un-wind the trailing cable when the hybrid electric vehicle moves away from the grid power source.

2. The system as claimed in claim 1, wherein the hybrid electric vehicle comprises a radio remote transmitter is configured to enable an operator to manage the hybrid electric vehicle's functions and movements from a distance.

3. The system as claimed in claim 2, wherein the radio remote transmitter comprises one or more designated buttons to manage the hybrid electric vehicle's functions and movements from a distance.

4. The system as claimed in claim 1, wherein the hybrid electric vehicle comprises a radio receiver is configured to receive control signals from the radio remote transmitter to control the hybrid electric vehicle's movements and functions.

5. The system as claimed in claim 1, wherein the changeover switch is configured to enable an operator to select a power source from at least one of: the power grid; and a battery unit.

6. The system as claimed in claim 1, wherein the self-adjusting cable guide is attached to the cable reeler support shaft through one or more bearings.

7. The system as claimed in claim 1, wherein the hybrid electric vehicle comprises a grid power source is configured to control the power distribution from the power grid to one or more subsystems of the hybrid electric vehicle.

8. The system as claimed in claim 7, wherein grid power source comprises an MCB is configured to enable the operator to supply electric power to the hybrid electric vehicle by turning on the MCB.

9. The system as claimed in claim 1, wherein the hybrid electric vehicle comprises a power control panel that is configured to supply 415 Volts of grid power or power from the battery unit to the electric motor through VFD (variable frequency drive).

10. The system as claimed in claim 1, wherein the hybrid electric vehicle comprises an electro-hydraulic module is configured to control the cable reeler's Rotational movements.
